(19) United States
(12) Patent Application Publication
(10) Pub. No.: US 2005/0209357 A1
(43) Pub. Date: Sep. 22, 2005

(54) Flame retardant radiation curable compositions

(76) Inventors: Jigeng Xu, Boothwyn, PA (US); Melvin Zussman, Wilmington, DE (US)

Correspondence Address: MAYER, BROWN, ROWE & MAW LLP, 1909 K STREET, N.W., WASHINGTON, DC, 20006, US

(21) Appl. No.: 11/001,635

(22) Filed: Dec. 2, 2004

Related U.S. Application Data
(60) Provisional application No. 60/526,150, filed on Dec. 2, 2003.

(51) Int. Cl. C08K 3/00

(52) U.S. Cl. 522/71

(57) ABSTRACT

The invention relates to a radiation curable composition comprising radiation curable components wherein the composition comprises at least two flame retardants and wherein the flame retardants belong to different classes of compounds, to a process for making three dimensional flame retardant articles and to a three dimensional article, made by rapid prototyping means, that passes the flame retardancy UL-94-V0 test.

The invention relates to flame-retardant radiation curable compositions, a method of making articles from the flame-retardant radiation curable compositions and flame-retardant articles.

Flame-retardant radiation curable compositions are known in the art. For example U.S. Pat. No. 4,970,135 discloses a flame-retardant composition that is used as a solder resist in the fabrication of printed circuit boards. The composition contains acrylates and a bromine-containing flame retardant in such an amount that the content of bromine in the total composition is in the range of 0.5 to 28% by weight. U.S. Pat. No. 6,323,253 describes UV curable silicone compositions having flame-retardant properties. The flame-retardant component is a combination of hydrated alumina and an organo-ligand complex of a transition metal or an organosiloxane ligand complex of a transition metal or a combination thereof.

Photocurable compositions that can be used for making flame-retardant three dimensional articles using rapid prototyping are not known. Commercial liquid stereolithographic (SL) resins for the rapid prototyping industry now are able to generate parts that simulate the performance parameters of a broad range of production materials from flexible thermoplastics to rigid composites. The main focus in the current resin development is still on improving mechanical properties while satisfying other requirements such as photo speed, accuracy, appearance, etc. With improved thermal and mechanical properties, SL resins have found increasing applications in various commercial fields and provided parts for functional testing under end use conditions, involving elevated temperatures or high voltages. Beyond offering functional prototypes, the current trend is towards developing strong and durable materials suitable for fully functional testing and short production runs or even rapid manufacturing. No commercial SL resin is known to be, however, capable of providing parts that satisfy the flame retardancy requirements as regulated in electronic, automotive, aerospace, and other industries. This is because typical stereolithographic resins, composed of acrylate, epoxy, vinyl ether, oxetane monomers and oligomers or combinations of them as the major reactive components, are inherently flammable due to their decomposition at high temperature to volatile, combustible products. The flammability of SL parts can be a hazard and restrict their applications. Therefore, an SL resin with desirable flame retardancy, i.e., meeting the stringent flammability rating of UL94 V0, and having good photo curing and mechanical properties shall provide a solution to those customers who seek accurate parts for not only prototyping purposes but also functional testing applications and short production runs.

### SUMMARY OF THE INVENTION

The present invention provides a radiation curable composition suitable for making three dimensional objects that are flame-retardant. Preferably the radiation curable composition of the present invention comprises at least two flame-retardant agents or flame retardants, wherein the flame retardants belong to different classes of compounds.

### DETAILED DESCRIPTION OF THE INVENTION

In the stereolithography industry, photocurable resins can be classified into three categories depending on the polymerizable, active species present in the systems. They are free radical polymerizable compositions, cationic polymerizable compositions, and currently widely used free radical and cationic dual curing hybrid resin compositions. In this invention, the radiation curable composition may contain cationically curable components, cationic photoinitiators, radically curable components, radical photoinitiators and additional components like for example hydroxy functional components, fillers, and additives. In one embodiment, the composition in this invention contains free radical polymerizable components. In another embodiment, the composition in this invention contains cationic polymerizable components. Preferably the compositions of the invention contain both cationically polymerizable components and radically polymerizable components in order to give a resin with good photo speed and an article having excellent accuracy and mechanical properties.

A) Cationically Curable Component

The present compositions may comprise at least one cationically curable component, e.g. at least one cyclic ether component, cyclic lactone component, cyclic acetal component, cyclic thioether component, spiro orthoester component, epoxy-functional component, vinyl ether component, and/or oxetane-functional component. Preferably, the present compositions comprise at least one component selected from the group consisting of epoxy-functional components and oxetane functional components. Preferably, the compositions comprise at least 20 wt % of cationically curable components, for instance at least 40 wt % to at least 60 wt %. Generally, the compositions comprise less than 99 wt % of cationically curable components, for instance less than 90 wt %, or less than 80 wt %.

The weight % (wt %) of a component throughout this specification is defined as the weight of a component relative to the weight of the organic fraction of the composition, unless specified otherwise. The organic fraction of the composition comprises organic materials, like monomers, polymers, flame retardants and additives, excluding inorganic fillers like for example silica. Inorganic materials that have been surface treated with organic materials and comprise a small amount of organic groups are considered to be inorganic fillers.

(A1) Epoxy-Functional Components

The present compositions preferably comprise at least one epoxy-functional component, e.g. an aromatic epoxy-functional component (“aromatic epoxy”) and/or an aliphatic epoxy-functional component (“aliphatic epoxy”). Epoxy-functional components are components comprising one or more epoxy groups, i.e. one or more three-member ring structures (oxiranes) according to formula (1): (1). 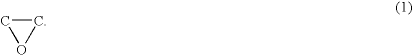
(A1-i) Aromatic Epoxies

Aromatic epoxies are components that comprise one or more epoxy groups and one or more aromatic rings. The compositions may comprise one or more aromatic epoxies.

Examples of aromatic epoxies include aromatic epoxies derived from a polyphenol, e.g. from bisphenols such as bisphenol A (4,4′-isopropylidenediphenol), bisphenol F (bis[4-hydroxyphenyl]methane), bisphenol S (4,4′-sulfonyldiphenol), 4,4′-cyclohexylidenebisphenol, 4,4′-biphenol, or 4,4′-(9-fluorenylidene)diphenol. The bisphenols may be alkoxylated (e.g. ethoxylated and/or propoxylated) and/or halogenated (e.g. brominated). Examples of bisphenol epoxies include bisphenol diglycidyl ethers.

Further examples of aromatic epoxies include triphenylolmethane triglycidyl ether, 1,1,1-tris(p-hydroxyphenyl)ethane triglycidyl ether, and aromatic epoxies derived from a monophenol, e.g. from resorcinol (for instance resorcin diglycidyl ether) or hydroquinone (for instance hydroquinone diglycidyl ether). Another example is nonylphenyl glycidyl ether.

In addition, examples of aromatic epoxies include epoxy novolacs, for instance phenol epoxy novolacs, and cresol epoxy novolacs. Commercial examples of cresol epoxy novolacs include, e.g., EPICLON N-660, N-665, N-667, N-670, N-673, N-680, N-690, and N-695, manufactured by Dainippon Ink and Chemicals, Inc. Examples of phenol epoxy novolacs include, e.g., EPICLON N-740, N-770, N-775, and N-865, manufactured by Dainippon Ink and Chemicals Inc. Also available from Dainippon Ink and Chemicals Inc. are naphthalenediol epoxy resins, e.g., EPICLON HP-4032, and EXA-4700, phenol-dicyclopentadiene glycidyl ether (i.e., EPICLON HP-7200), and tert-butyl-catechol epoxy resin (i.e., EPICLON HP-820). Other naphthyl epoxy resins include for example (1-naphthyloxymethyl)oxirane, and (2-naphthyloxymethyl)oxirane.

In one embodiment of the invention, the present compositions may comprise at least 10 wt % of one or more aromatic epoxies.

(A1-ii) Aliphatic Epoxies

Aliphatic epoxies are components that comprise one or more epoxy groups and are absent an aromatic ring. The compositions may comprise one or more aliphatic epoxies.

Examples of aliphatic epoxies include glycidyl ethers of C₂-C₃₀ alkyls; 1,2 epoxies of C₃-C₃₀ alkyls; mono and multi glycidyl ethers of aliphatic alcohols and polyols such as 1,4-butanediol, neopentyl glycol, cyclohexane dimethanol, dibromo neopentyl glycol, trimethylol propane, polytetramethylene oxide, polyethylene oxide, polypropylene oxide, glycerol, and alkoxylated aliphatic alcohols and polyols.

In one embodiment, it is preferred that the aliphatic epoxies comprise one or more cycloaliphatic ring structures. For instance, the aliphatic epoxies may have one or more cyclohexene oxide structures, e.g. two cyclohexene oxide structures. Examples of aliphatic epoxies comprising a ring structure include hydrogenated bisphenol A diglycidyl ethers, hydrogenated bisphenol F diglycidyl ethers, hydrogenated bisphenol S diglycidyl ethers, bis(4-hydroxycyclohexyl)methane diglycidyl ether, 2,2-bis(4-hydroxycyclohexyl)propane diglycidyl ether, 3,4-epoxycyclohexylmethyl-3,4-epoxycyclohexanecarboxylate, 3,4-epoxy-6-methylcyclohexylmethyl-3,4-epoxy-6-methylcyclohexanecarboxylate, di(3,4-epoxycyclohexylmethyl)hexanedioate, di(3,4-epoxy-6-methylcyclohexylmethyl)hexanedioate, ethylenebis(3,4-epoxycyclohexanecarboxylate), ethanedioldi(3,4-epoxycyclohexylmethyl)ether, and 2-(3,4-epoxycyclohexyl-5,5-spiro-3,4-epoxy)cyclohexane-1,3-dioxane.

Examples of aliphatic epoxies are also listed in U.S. Pat. No. 6,410,127, which is hereby incorporated in its entirety by reference.

(A2) Oxetane-Functional Components

The present compositions may comprise one or more oxetane-functional components (“oxetanes”). Oxetanes are components comprising one or more oxetane groups, i.e. one or more four-member ring structures according to formula (5):

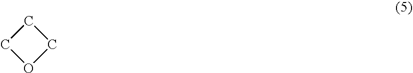

Examples of oxetanes include components represented by the following formula (6): 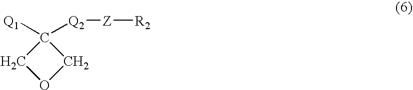
wherein
Q₁ represents a hydrogen atom, an alkyl group having 1 to 6 carbon atoms (such as a methyl, ethyl, propyl, or butyl group), a fluoroalkyl group having 1 to 6 carbon atoms, an allyl group, an aryl group, a furyl group, or a thienyl group;
Q₂ represents an alkylene group having 1 to 6 carbon atoms (such as a methylene, ethylene, propylene, or butylene group), or an alkylene group containing an ether linkage, for example, an oxyalkylene group, such as an oxyethylene, oxypropylene, or oxybutylene group
Z represents an oxygen atom or a sulphur atom; and
R₂ represents a hydrogen atom, an alkyl group having 1-6 carbon atoms (e.g. a methyl group, ethyl group, propyl group, or butyl group), an alkenyl group having 2-6 carbon atoms (e.g. a 1-propenyl group, 2-propenyl group, 2-methyl-1-propenyl group, 2-methyl-2-propenyl group, 1-butenyl group, 2-butenyl group, or 3-butenyl group), an aryl group having 6-18 carbon atoms (e.g. a phenyl group, naphthyl group, anthranyl group, or phenanthryl group), a substituted or unsubstituted aralkyl group having 7-18 carbon atoms (e.g. a benzyl group, fluorobenzyl group, methoxy benzyl group, phenethyl group, styryl group, cynnamyl group, ethoxybenzyl group), an aryloxyalkyl group (e.g. a phenoxymethyl group or phenoxyethyl group), an alkylcarbonyl group having 2-6 carbon atoms (e.g. an ethylcarbonyl group, propylcarbonyl group, or butylcarbonyl group), an alkoxy carbonyl group having 2-6 carbon atoms (e.g. an ethoxycarbonyl group, propoxycarbonyl group, or butoxycarbonyl group), an N-alkylcarbamoyl group having 2-6 carbon atoms (e.g. an ethylcarbamoyl group, propylcarbamoyl group, butylcarbamoyl group, or pentylcarbamoyl group), or a polyether group having 2-1000 carbon atoms.
   (B) Cationic Photoinitiators

The present composition may comprise one or more cationic photoinitiators, i.e. photoinitiators that, upon exposure to actinic radiation, form cations that can initiate the reactions of cationically polymerizable components, such as epoxies or oxetanes.

Examples of cationic photoinitiators include, for instance, onium salts with anions of weak nucleophilicity. Examples include halonium salts, iodosyl salts or sulfonium salts, such as are described in published European patent application EP 153904 and WO 98/28663, sulfoxonium salts, such as described, for example, in published European patent applications EP 35969, 44274, 54509, and 164314, or diazonium salts, such as described, for example, in U.S. Pat. Nos. 3,708,296 and 5,002,856. All eight of these disclosures are hereby incorporated in their entirety by reference. Other examples of cationic photoinitiators include metallocene salts, such as described, for instance, in published European applications EP 94914 and 94915, which applications are both hereby incorporated in their entirety by reference.

In one embodiment, the present compositions comprise one or more photoinitiators represented by the following formula (7) or (8): 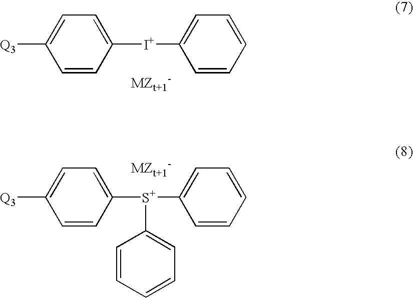
wherein
Q₃ represents a hydrogen atom, an alkyl group having 1 to 18 carbon atoms, or an alkoxyl group having 1 to 18 carbon atoms;
M represents a metal atom, e.g. antimony;
Z represents a halogen atom, e.g. fluorine; and
t is the valent number of the metal, e.g. 5 in the case of antimony.

In one embodiment, the present compositions comprise 0.1-15 wt % of one or more cationic photoinitiators, for instance 1-10 wt %.

(C) Free Radical Polymerizable Components

The present invention may comprise one or more free radical curable components, e.g. one or more free radical polymerizable components having one or more ethylenically unsaturated groups, such as (meth)acrylate (i.e. acrylate and/or methacrylate) functional components.

Examples of monofunctional ethylenically unsaturated components include acrylamide, N,N-dimethylacrylamide, (meth)acryloylmorpholine, 7-amino-3,7-dimethyloctyl(meth)acrylate, isobutoxymethyl(meth)acrylamide, isobornyloxyethyl (meth)acrylate, isobornyl(meth)acrylate, 2-ethylhexyl(meth)acrylate, ethyldiethylene glycol (meth)acrylate, t-octyl(meth)acrylamide, diacetone (meth)acrylamide, dimethylaminoethyl(meth)acrylate, diethylaminoethyl(meth)acrylate, lauryl(meth)acrylate, dicyclopentadiene (meth)acrylate, dicyclopentenyloxyethyl(meth)acrylate, dicyclopentenyl (meth)acrylate, N,N-dimethyl(meth)acrylamidetetrachlorophenyl(meth)acrylate, 2-tetrachlorophenoxyethyl(meth)acrylate, tetrahydrofurfuryl(meth)acrylate, tetrabromophenyl(meth)acrylate, 2-tetrabromophenoxyethyl(meth)acrylate, 2-trichlorophenoxyethyl(meth)acrylate, tribromophenyl(meth)acrylate, 2-tribromophenoxyethyl(meth)acrylate, 2-hydroxyethyl(meth)acrylate, 2-hydroxypropyl (meth)acrylate, vinylcaprolactam, N-vinylpyrrolidone, phenoxyethyl(meth)acrylate, butoxyethyl(meth)acrylate, pentachlorophenyl(meth)acrylate, pentabromophenyl (meth)acrylate, polyethylene glycol mono(meth)acrylate, polypropylene glycol mono(meth)acrylate, bornyl(meth)acrylate, and, methyltriethylene diglycol (meth)acrylate.

Examples of the polyfunctional ethylenically unsaturated components include ethylene glycol di(meth)acrylate, dicyclopentenyl di(meth)acrylate, triethylene glycol diacrylate, tetraethylene glycol di(meth)acrylate, tricyclodecanediyldimethylene di(meth)acrylate, trimethylolpropane tri(meth)acrylate, ethoxylated trimethylolpropane tri(meth)acrylate, propoxylated trimethylolpropane tri(meth)acrylate, tripropylene glycol di(meth)acrylate, neopentyl glycol di(meth)acrylate, both-terminal (meth)acrylic acid adduct of bisphenol A diglycidyl ether, 1,4-butanediol di(meth)acrylate, 1,6-hexanediol di(meth)acrylate, polyethylene glycol di(meth)acrylate, (meth)acrylate-functional pentaerythritol derivatives (e.g. pentaerythritol tri(meth)acrylate, pentaerythritol tetra(meth)acrylate, dipentaerythritol hexa(meth)acrylate, dipentaerythritol penta(meth)acrylate, or dipentaerythritol tetra(meth)acrylate), ditrimethylolpropane tetra(meth)acrylate, ethoxylated bisphenol A di(meth)acrylate, propoxylated bisphenol A di(meth)acrylate, ethoxylated hydrogenated bisphenol A di(meth)acrylate, propoxylated-modified hydrogenated bisphenol A di(meth)acrylate, and ethoxylated bisphenol F di(meth)acrylate.

In one embodiment, the present compositions comprise one or more components having at least 3 (meth)acrylate groups, for instance 3-6 (meth)acrylate groups or 5-6 (meth)acrylate groups.

If present, the compositions may comprise at least 3 wt % of one or more free radical polymerizable components, for instance at least 5 wt % or at least 9 wt %. Generally, the compositions comprise less than 80 wt % of free radical polymerizable components, for instance less than 70 wt %, less than 60 wt %, less than 50 wt %, less than 35 wt % or less than 25 wt %.

(D) Free Radical Photoinitiators

The compositions may employ one or more free radical photoinitiators. Examples of free radical photoinitiators include benzophenones (e.g. benzophenone, alkyl-substituted benzophenone, or alkoxy-subsituted benzophenone); benzoins, e.g. benzoin, benzoin ethers, such as benzoin methyl ether, benzoin ethyl ether, and benzoin isopropyl ether, benzoin phenyl ether, and benzoin acetate; acetophenones, such as acetophenone, 2,2-dimethoxyacetophenone, 4-(phenylthio)acetophenone, and 1,1-dichloroacetophenone; benzil, benzil ketals, such as benzil dimethyl ketal, and benzil diethyl ketal; anthraquinones, such as 2-methylanthraquinone, 2-ethylanthraquinone, 2-tertbutylanthraquinone, 1-chloroanthraquinone, and 2-amylanthraquinone; triphenylphosphine; benzoylphosphine oxides, such as, for example, 2,4,6-trimethylbenzoyldiphenylphosphine oxide; thioxanthones and xanthones, acridine derivatives, phenazene derivatives, quinoxaline derivatives or I-phenyl-1,2-propanedione-2-O-benzoyloxime, I-aminophenyl ketones or I-hydroxyphenyl ketones, such as I-hydroxycyclohexyl phenyl ketone, phenyl(1-hydroxyisopropyl)ketone and 4-isopropylphenyl(1-hydroxyisopropyl)ketone, or triazine compounds, for example, 4′″-methyl thiophenyl-1-di(trichloromethyl)-3,5-S-triazine, S-triazine-2-(stilbene)-4,6-bistrichloromethyl, and paramethoxy styryl triazine.

Further suitable free radical photoinitiators include the ionic dye-counter ion compounds, which are capable of absorbing actinic rays and producing free radicals, which can initiate the polymerization of the acrylates. See, for example, published European Patent Application 223587, and U.S. Pat. Nos. 4,751,102, 4,772,530 and 4,772,541, all four of which are hereby incorporated in their entirety by reference.

In one embodiment, the present compositions comprise 0.1-15 wt % of one or more free radical photoinitiators, for instance 1-10 wt %.

(E) Flame-Retardant Agents or Flame Retardants

Flame retardants are added to polymeric materials to enhance the flame-retardant properties of the polymers. Flame retardants can be divided into different classes. Examples of such different classes of flame retardants include (1) halogenated flame retardants, i.e., components containing chlorine or bromine atoms; (2) P-containing flame retardants, like for example organophosphorus flame retardants; (3)nitrogen containing flame retardants, such as for example melamine-based or isocyanurate-based products; (4) inorganic flame retardants, such as aluminum trihydrate (ATH), magnesium hydroxide (MDH), zinc borate, ammonium polyphosphate, red phosphorus, etc. Some flame retardants may contain both halogen and phosphorus, such as for example bromine-containing phosphate esters, or both halogen and nitrogen, such as for example tris(2,3-dibromopropyl)isocyanurate. Flame retardants can be either reactive or additive, depending on whether they can be built chemically into the polymer molecule by participating in the reactions with the other components in the composition. In addition, antimony oxides are widely used together with halogenated flame retardants as a synergist.

The compositions of the invention contain flame retardants. It has been found that relatively high loadings of flame retardants are needed in order to pass the stringent vertical burning test of UL94 for an article built of a radiation curable composition. Addition of such high amounts of flame retardants may interfere with cure properties of the composition (like decrease of cure speed or the depth of light penetration) or it may cause adverse effect on the thermal and mechanical properties of the cured article or three dimensional object. It has surprisingly been found that combination of at least two different flame retardants in a radiation curable composition, whereby the flame retardants are stemming from at least two different classes of flame retardants, gives a flame-retardant article. Surprisingly the level of flame retardants may be substantially reduced to a level that does not interfere either with the cure properties of the composition or with the properties of the cured object, relative to the use of a single type of flame retardant.

Preferably the flame retardants are chosen from the group consisting of brominated compounds, P-containing compounds (like organophosphorus compounds) and aluminum hydroxide.

In one preferred embodiment of the present invention, the composition comprises at least one bromine-containing flame retardant and at least one P-containing flame retardant, whereby the amount of Br- and P-containing flame retardant is defined by the formula:
5≦[P]+0.25*[Br]≦10
wherein [P] is the wt % of (the element)phosphorous in the organic part of the resin composition, [Br] is the wt % of (the element) Br in the organic part of the resin composition, and wherein [P]>0.1 wt %. Preferably, [P] is >0.2 wt %.

More preferably, the amount of flame retardant is defined as
5≦[P]+0.25*[Br]≦8,
wherein [P], [Br] have the meaning defined above, and [P]>0.25 wt %.

In another preferred embodiment of the present invention, the composition comprises at least one bromine-containing flame retardant and aluminum hydroxide (i.e., hydrated alumina, ATH), whereby the wt % of (the element) bromine in the organic part of the resin composition is 5-30 wt % in combination with about 30-50 wt % of ATH in the resin composition.

E(1) Halogenated Flame Retardants

Examples of commercially available halogen (bromine and chlorine) containing epoxy resins and oligomers include (bromomethyl)oxirane, 1,2-dibromopropyl glycidyl ether, 2,6-dibromo-4-tert-butylphenyl 2,3-epoxypropyl ether, 2,2-bis(bromomethyl)-1,3-propanediol diglycidyl ether, 2,4,6-tribromo-3-sec-butylphenyl 2,3-epoxypropyl ether, 2,6-dibromo-4-isopropylphenyl 2,3-epoxypropyl ether, 4-bromophenyl glycidyl ether, 2-bromophenyl glycidyl ether, dibromophenylglycidylether, 2,6-dibromophenol glycidyl ether, dibromocresyl glycidyl ether, [(3,5-dibromo-2-methylphenoxy)methyl]oxirane, 2,6-dibromo-4-methylphenyl glycidyl ether, 2,4-dibromo-6-methylphenyl glycidyl ether, dibromo-p-cresylglycidyl ether, dibromo-o-cresylglycidyl ether, [(2,4-dibromo-5-methylphenoxy)methyl]oxirane, [(2,4,6-tribromophenoxy)methyl]oxirane, bis(2,3-epoxypropyl) 3,4,5,6-tetrabromophthalate, tetrabromobisphenol A-tetrabromobisphenol A-diglycidyl-ether oligomer, tetrabromobisphenol A diglycidyl ether, 2,2-bis(4-glycidyloxy-3,5-dibromophenyl)propane polymer, tetrabromobisphenol A-epichlorohydrin polymer, 2,2′-[(1-methylethylidene)bis[(3,5-dibromo-4,1-phenylene)oxymethylene]]bisoxirane, tetrabromobisphenol A-bisphenol A-epichlorohydrin oligomers, and brominated epoxy prepolymers and oligomers.

Examples of halogenated oxetanes include 3,3-bis(bromomethyl)oxetane, dibromooxetane, 3-(bromomethyl)-3-methyl oxetane, 3,3-bis(chloromethyl)oxetane.

Examples of halogen-containing alcohols and phenols include tetrabromobisphenol A, tetrabromophthalic acid diester/ether diol, tetrabromobisphenol A bis(2-hydroxyethyl oxide), 2,2-bis(bromomethyl)-1,3-propanediol, 2,2,6,6-tetrakis(bromomethyl)-4-oxaheptane-1,7-diol, 2,3-dibromo-1-propanol, 2,3-dibromo-2-butene-1,4-diol, 2,2,2-tris(bromomethyl)ethanol, tribromoneopentyl alcohol, 2,4,6-tribromophenol, pentabromophenol, 2,4-dibromophenol, tetrabromobisphenol S, 4,4′-methylenebis[2,6-dibromophenol], 2,3,5,6-tetrabromo-1,4-benzenedimethanol.

Examples of halogen-containing acrylates and methacrylates include 2,2-bis(bromomethyl)-1,3-propanediyl diacrylate, dibromoneopentyl glycol dimethacrylate, tetrabromobisphenol A diacrylate, tetrabromobisphenol A monomethacrylate, tetrabromobisphenol A bis(2-hydroxyethyl)ether bisacrylate, (tetrabromo-1,4-phenylene)bismethylene diacrylate, (1-methylethylidene)bis(2,6-dibromo-4,1-phenylene) bismethacrylate, pentabromophenyl methacrylate, pentabromobenzyl acrylate, 2,4,6-tribromophenyl methacrylate, tribromophenyl methacrylate, 2-(tribromophenoxy)ethyl methacrylate, 2-(2,4,6-tribromophenoxy)ethyl acrylate, 2,4,6-tribromophenyl acrylate, 2-[2-(2,4,6-tribromophenoxy)ethoxy]ethyl methacrylate, etc.

More examples of ethylenically unsaturated halogen-containing compounds include vinyl bromide, 4-bromostyrene, 2,3,4,5,6-pentabromostyrene, tetrabromobisphenol A diallyl ether, tribromophenyl allyl ether, pentabromophenyl allyl ether, tetrabromobisphenol S diallyl ether, and diallyl tetrabromophthalate.

Examples of halogenated flame retardants include tetrabromocyclooctane, dibromoethyldibromocyclohexane, hexabromocyclododecane, 1,2,5,6,9,10-hexabromocyclododecane, tetrabromobutane, tribromodiphenyl ether, tetrabromodiphenyl ether, pentabromoethylbenzene, pentabromotoluene, pentabromodiphenyl ether, hexabromodiphenyl ether, octabromodiphenyl ether, decabromodiphenyl ether, decabromodiphenyl ethane, bis(tribromophenoxy)ethane, bis(tribromophenoxy)ethane, decabromobiphenyl, 1,3-bis(pentabromophenoxy)propane, 1,6-bis(pentabromophenoxy)hexane, pentabromo(tetrabromophenoxy)benzene, tetradecabromodiphenoxy benzene, 1,2,4,5-tetrabromo-3,6-bis[(pentabromophenoxy)methyl]benzene, bis(pentabromobenzyl) tetrabromoterephthalate, pentakis(bromomethyl)benzene, bis(2,4,6-tribromophenyl) carbonate, tetrabromobisphenol A bis(2,3-dibromopropyl)oxide, tetrabromobisphenol A dimethyl ether, tetrabromophthalic anhydride, tribromophenyl maleimide, ethylene bis(tetrabromophthalimide), tetrabromophthalimide, ethylene bis(dibromonorbornanedicarboximide), tetrabromobisphenol S bis(2,3-dibromopropyl ether), disodium tetrabromophthalate, chlorinated paraffin, and tetrabromobisphenol A based carbonates and epoxy oligomer, prepolymer, and copolymer derivatives. Examples of such tetrabromobisphenol A based polymers include epichlorohydrin-tetrabromobisphenol A-2,4,6-tribromophenol copolymer, tetrabromobisphenol A-oxirane polymer, tetrabromobisphenol A oligomeric reaction products with 1-chloro-2,3-epoxypropane and polymethylenepolyphenylene polyisocyanate, ethylene dibromide-tetrabromobisphenol A copolymer, bisphenol A-bisphenol A diglycidyl ether-tetrabromobisphenol A copolymer, bisphenol A diglycidyl ether-tetrabromobisphenol A copolymer, tetrabromobisphenol A-bisphenol A-phosgene polymer, tetrabromobisphenol A carbonate oligomer and polymer, carbonic dichloride polymer with tetrabromobisphenol A and phenol, carbonic dichloride polymer with tetrabromobisphenol A and bis(2,4,6-tribromophenyl), and condensate of 2,4,6-tribromophenol to polycondensate of tetrabromobisphenol A-4,4′-isopropylidenediphenol-phosgene.

More examples of halogen-containing polymeric flame retardants include 2,4-dibromophenol polymer with (chloromethyl)oxirane, poly(tribromophenyl acrylate), poly(dibromophenylene oxide), poly(pentabromobenzyl acrylate), polydibromostyrene, poly(dibromostyrene), brominated polystyrene, polytribromostyrene, brominated polyetherpolyol, methanol-terminated carbonic dichloride polymer with tetrabromobisphenol A, 4-aminobenzenesulfonamide polymer with (chloromethyl)oxirane and tetrabromobisphenol A and 2,2′-[(1-methylethylidene)bis(4,1-phenyleneoxymethylene)]bis[oxirane], pentabromo-N-(pentabromophenyl)aniline, brominated 1,3-butadiene homopolymer, brominated epoxy resin end-capped with tribromophenol, brominated trimethylphenylindane, tetrabromobisphenol A oligomeric reaction products with 1-chloro-2,3-epoxypropane and acrylic acid, epoxy phenolic novolac resin reaction products with tetrabromobisphenol A and methacrylic acid, tetrabromobisphenol A polymer with (chloromethyl)oxirane and bisphenol A and oxirane, 4,5,6,7-tetrabromo-1,3-isobenzofurandione polymer with α-hydro-ω-hydroxypoly[oxy(methyl-1,2-ethanediyl)] and bisphenol A diglycidyl ether, tetrabromobisphenol A polymer with (chloromethyl)oxirane and bromophenyl oxiranylmethyl ether, dibromoneopentyl glycol-epichlorohydrin copolymer, and silicic acid tetraethyl ester reaction products with 2,2-bis(bromomethyl)-1,3-propanediol.

Examples of halogen- and nitrogen-containing flame retardants include 2,4,6-tris(2,4,6-tribromophenoxy)-1,3,5-triazine, 1,3,5-tris(2,3-dibromopropoxy)-2,4,6-triazine, Saytex 8010 proprietary product, 2,2-bis(3,5-dibromo-4-hydroxyphenyl)propane-cyanuric chloride copolymer, 2,2-bis(3,5-dibromo-4-hydroxyphenyl)propane-2,4,6-tribromophenol-2,4,6-trichloro-1,3,5-triazine polycondensate, and 1,3,5-tris(2,3-dibromopropyl)isocyanurate.

Preferably the composition comprises a flame retardant from the group consisting of bromine-containing epoxy resins/oligomers/prepolymers, Br-containing acrylates/methacrylates, Br-containing polyols and polyphenols, and brominated oxetanes, or a combination of two or more of the above. Also preferably, the halogen-containing flame retardant forms a solution with other organic ingredients in the composition.

Preferably, the compositions comprise, relative to the total weight of the organic fraction of the composition, at least 5 wt % of (the element) Br from the Br-containing flame retardant, for instance at least 10 wt %. Generally, the compositions comprise, relative to the total weight of the organic fraction of the composition, less than 40 wt % of Br from the Br-containing flame retardant, for instance less than 30 wt %, or less than 25 wt %.

E(2) P- and/or N-Containing Flame Retardants

Examples of commercially available P-containing flame retardants include alkyl and aryl phosphates, phosphonates, phosphinates, and phosphine oxides. Examples of such compounds include triphenylphosphate, tricresyl phosphate, trixylylphosphate, cresyl diphenyl phosphate, diphenyl xylyl phosphate, 2-biphenylyl diphenyl phosphate, butylated triphenyl phosphate, tert-butylphenyl diphenyl phosphate, bis-(tert-butylphenyl)phenylphosphate, tris(tert-butylphenyl)phosphate, tris(2,4-di-tert-butylphenyl) phosphate, isopropylated triphenyl phosphates, isopropylated triphenyl phosphate residue, isopropylated tert-butylated triphenylphosphate, tert-butylated triphenyl phosphates, isopropylphenyl diphenyl phosphate, bis(isopropylphenyl)phenylphosphate, 3,4-diisopropylphenyl diphenyl phosphate, tris(isopropylphenyl)phosphate, (1-methyl-1-phenylethyl)phenyl diphenyl phosphate, nonylphenyl diphenyl phosphate, 4-[4-hydroxyphenyl(propane-2,2-diyl)]phenyl diphenyl phosphate, 4-hydroxyphenyl diphenyl phosphate, resorcinol bis(diphenyl phosphate), bisphenol A bis(diphenyl phosphate), bis(ditolyl)isopropylidenedi-p-phenylene bis(phosphate), O,O,O′,O′-tetrakis(2,6-dimethylphenyl) O,O′-m-phenylene bisphosphate, diisodecyl phenyl phosphate, dibutyl phenyl phosphate, methyl diphenyl phosphate, butyl diphenyl phosphate, 2-ethylhexyl diphenyl phosphate, diphenyl octyl phosphate, isooctyl diphenyl phosphate, diphenyl isodecyl phosphate, isopropyl diphenyl phosphate, diphenyl lauryl phosphate, tetradecyl diphenyl phosphate, cetyl diphenyl phosphate, tar acids cresylic diphenyl phosphates, diphenyl 2-(methacryloyloxy)ethyl phosphate, triethyl phosphate, tri(butoxyethyl) phosphate, 3-(dimethylphosphono)propionic acid methyloamide, dimethyl methyl phosphonate, diethyl ethyl phosphonate, dimethyl propyl phosphonate, diethyl [(diethanolamino)methyl]phosphonate, bis[(5-ethyl-2-methyl-1,3,2-dioxaphosphorinan-5-yl)methyl]methyl phosphonate P,P′-dioxide, (5-ethyl-2-methyl-1,3,2-dioxaphosphorinan-5-yl)methyl dimethyl phosphonate P-oxide, aluminium bis(4,4′,6,6′-tetra-tert-butyl-2,2′-methylenediphenyl phosphate)hydroxide, bis[p-(1,1,3,3-tetramethylbutyl)phenyl]hydrogen phosphate, phosphinylidynetrimethanol, sec-butylbis(3-hydroxypropyl)phosphine oxide, tris(3-hydroxypropyl)phosphine oxide, isobutylbis(hydroxypropyl)phosphine oxide, isobutylbis(hydroxymethyl)phosphine oxide, triphenylphosphine monoxide, and tris(2,3-epoxypropyl)phosphate. Moreover, melamine polyphosphate also is commercially available.

Nitrogen-containing compounds also find usage as flame retardants. Examples of such compounds include melamine cyanurate, 1,3,5-tris(2,3-dibromopropyl) isocyanurate, 1,3,5-triglycidyl isocyanurate, 1,3,5-tris(2-hydroxyethyl)isocyanurate, tris(2-acryloxyethyl)isocyanurate, 1,3,5-triazine-2,4,6-triyltri-2,1-ethanediyl triacrylate, tris(hydroxyethyl)isocyanurate diacrylate, tris(2-hydroxyethyl)isocyanurate trimethacrylate, and tris(2-methacryloyloxyethyl)isocyanurate.

Preferably the composition of the present invention contains a phosphorus-containing flame retardant with high thermal stability and high hydrolytic stability. Examples of such P-containing flame retardants include those from the group consisting of aromatic phosphate esters and biphosphate esters. Also preferred are P-containing flame retardants having one or more reactive groups such as for example hydroxyls, oxetanes, epoxies, methacrylates or acrylates.

Preferably, the compositions comprise, relative to the total weight of the organic fraction of the composition, at least 0.1 wt % of (the element) P from the P-containing flame retardants, for instance at least 0.2 wt %. Generally, the compositions comprise, relative to the total weight of the organic fraction of the composition, less than 5 wt % of P from the P-containing flame retardants, for instance less than 3.5 wt %, for instance less than 2.5 wt %.

E(3) Inorganic Flame Retardants

Inorganic flame retardants include aluminum trihydrate (ATH), magnesium hydroxide (MDH), zinc borate, inorganic phosphorus compounds, such as APP ammonium polyphosphate and red phosphorus.

In one embodiment of the invention, the compositions may comprise, relative to the total weight of the composition, at least 20 wt % of inorganic flame retardant, for instance at least 40 wt %. Generally, the compositions may comprise, relative to the total weight of the composition, less than 60 wt % of inorganic flame retardant.

E(4) Flame Retardants Belonging to Two Different Classes

Flame retardants that belong to two different classes are for example flame retardants comprising a halogen (preferably bromine) and a phosphorous atom, like for example in a phosphate group.

Examples of commercially available halogen (preferably bromine)- and phosphorus-containing flame retardants include tris(bromocresyl)phosphate, tris(4-bromo-3-methylphenyl)phosphate, tris(dibromophenyl)phosphate, tris(2,4,6-tribromophenyl) phosphate, tris(tribromophenyl)phosphate, tris(tribromoneopentyl)phosphate, tris(2-bromooctyl)phosphate, tris(2-bromoisopropyl)phosphate, tris(2-bromopropyl)phosphate, tris(bromopropyl)phosphate, tris(chlorobromopropyl)phosphate, tris(2,3-dibromopropyl) phosphate, bis(2,3-dibromopropyl)phosphate, mixed 3-bromo-2,2-dimethylpropyl and 2-bromoethyl and 2-chloroethyl phosphoric acid esters, P,P′-[2,2-bis(bromomethyl)propane-1,3-diyl]-P,P′-bis(2-bromo-3-chloropropyl)-P,P-bis(2,3-dichloropropyl)bis(phosphate), tri(2-bromoethyl)phosphate, brominated cresyl diphenyl phosphate, tris(2-chloro-1-methylethyl)phosphate, tris(2-chloro-1-(chloromethyl)ethyl)phosphate, tetrakis(2-chloroethyl)dichloroisopentyldiphosphate, 2,2′-[[2,2-bis(chloromethyl)propane-1,3-diyl]bis(oxy)]bis[5,5-dimethyl-1,3,2-dioxaphosphorinane]2,2′-dioxide, tris[2-bromo-1-(chloromethyl)ethyl]phosphate, bromoethyl bromopentyl chloroethyl phosphate, bis(1,3-dichloro-2-propyl)3-chloro-2,2-dibromomethyl-1-propyl phosphate, tris(2-bromo-3-chloropropyl)phosphate, bis(bromopropyl) chloroethyl phosphate, 1,2-dibromo-2,2-dichloroethyl dimethyl phosphate, 2-bromo-1-(chloromethyl)ethyl 3-bromo-2,2-dimethylpropyl 2-chloro-1-(chloromethyl)ethyl phosphate ester, tris(1-bromo-3-chloropropyl)phosphate, 2,4-dibromophenyl diphenyl phosphate, o-chlorophenyl diphenyl phosphate.

The compositions may comprise, relative to the total weight of the organic fraction of the composition, at least 5 wt % of Br from the mixed class flame retardant, for instance at least 10 wt %. Generally, the compositions comprise, relative to the total weight of the organic fraction of the composition, less than 40 wt % of Br from the mixed class flame retardant, for instance less than 30 wt %, or less than 25 wt %. Preferably, the mixed class flame retardant has good thermal stability and high hydrolytic stability. Examples of such flame retardants include those from the group consisting of halogenated aromatic phosphate esters and biphosphate esters.

Fillers may be used to reduce the loading of flame retardants in the composition and improve the quality and strength of parts. Such fillers include conventional fillers and nanometer-size fillers.

The present invention also relates to a method for making a three dimensional object, comprising the steps of
(1) coating a layer of a composition onto a surface;
(2) exposing said layer imagewise to actinic radiation to form an imaged cross-section;
(3) coating a further layer of the composition onto said imaged cross-section;
(4) exposing said further layer imagewise to actinic radiation to form an additional imaged cross-section;
(5) repeating steps (3) and (4) a sufficient number of times in order to build up a three dimensional article;
(6) optionally, post-curing the three-dimensional article.
   wherein the composition comprises one or more flame retardants, wherein the composition can be cured to a testspecimen having a size of 125 mm in length, 13 mm in width and 3.2 mm in thickness and wherein the testpiece after UV postcure passes the UL-94-V0 flammability test.

The invention also relates to the use of a radiation curable composition comprising one or more flame retardants for making three dimensional objects, wherein the object passes the flame retardancy UL-94-V0 test.

The invention further relates to a three dimensional article, made by rapid prototyping means, that passes the flame retardancy UL-94-V0 test.

A standard test for measuring flammability and/or combustibility is known as Underwriters Laboratories UL94, “Test for Flammability of Plastic Materials—UL-94” (Jul. 29, 1997), the disclosure of which is hereby expressly incorporated herein by reference. In this test, the materials are classified as V-0, V-1, or V-2 depending on the flame-retardant performance.

Particularly desirable materials in accordance with this invention should reach a V-0 classification, although certain formulations may be classified at a lower level (such as V-1), depending on the end use for which the material is intended. Details of this test and the performance of cured reaction products within the scope of the invention under test conditions are provided below in the examples.

A radiation curable liquid composition was prepared by weighing all the organic components into a plastic container under mechanical stirring at room temperature or up to 50-60° C. for about 2 hrs to 1 day in order to facilitate the dissolution of solid organic ingredients until a homogeneous mixture was obtained. The liquid mixture was then filtered off into a vat of stereolithography apparatus using a medium paint filter before fabrication of parts. For a starting component containing nanometer-size particles pre-dispersed in organic medium, it was treated like a liquid resin. Otherwise, when a micrometer-size inorganic component was present in the final composition, the filtered liquid resin was further mixed into the inorganic component until a good suspension was obtained for building parts. In this case, the composition was checked for any settling of particles before and after building each batch of test parts and gentle mixing in the vat was provided when necessary.

Compositions were prepared by mixing the components listed in Tables 2 and 3 (Comparative Experiments) and Tables 4-6 (Examples) for epoxy and acrylate hybrid resins, along with Table 7 for radically curable resins, with amounts of the components being listed in parts by weight. The thus prepared compositions were subsequently analyzed in accordance with the Test Methods described below. The test results are also listed in Tables 2-7.

Test Methods

(a) Tensile Strength, Young's modulus, and Elongation at Break

Tensile data was obtained by testing tensile bars (“dogbones”) made by first consecutively imaging 150 μm thick layers of the composition to be tested in a rapid prototyping machine. Each cross-sectional layer of the tensile bar was given exposure sufficient to polymerize the composition at a 250 μm depth, providing approximately 100 μm of overcure or engagement cure to assure adhesion to the previously coated and exposed layer. The layers were exposed with a laser emitting in the ultraviolet (UV) region at 354.7 nm. The resulting tensile bars/dogbones were approximately 150 mm long and had a cross-section in the narrowed portion of approximately 1 cm×1 cm. After preparation of the tensile bar in the rapid prototyping machine, the tensile bar was removed from the machine, washed with either tri(propyleneglycol)methyl ether (“TPM”) or propylene carbonate and with isopropanol, and placed in a post-curing apparatus (“PCA” sold by 3-D Systems, 10 bulb unit using Phillips TLK/05 40 W bulbs). In the PCA, the tensile bar was postcured by subjecting it to 60 minutes of UV radiation at room temperature. Optionally, the tensile bar was further subjected to 130° C. or 160° C. thermal post-cure for two hours after these 60 minutes in the PCA. The tensile tests to determine tensile strength, Young's modulus, and elongation at break were run one week after preparation of the UV-post-cured tensile bar and at least one day after for the UV and thermally postcured bar. The tensile tests were conducted in accordance with ASTM D638, which is hereby incorporated in its entirety by reference, except that no provision was made for controlling the room temperature and humidity and the bars were not equilibrated for 2 days. The reported data is the average of three measurements.

(b) E10, Dₚ, and E_{c}

The photoproperties E_{c} (mJ/cm²), Dₚ (μm), and E10 (mJ/cm²) represent the photoresponse (in this case thickness of layer formed) of a particular formulation to exposure by a single wavelength or range of wavelengths. In the instant Examples and Comparative experiments, at least 20 grams of composition were poured into a 100 mm diameter petri-dish and allowed to equilibrate to approximately 30° C. and 30% RH. The samples were then scanned in a line-by-line fashion using a focused laser beam of approximately 100-140 mW. The laser, a frequency tripled YAG laser, had an output wavelength of 354.7 nm and was pulsed at 80 KHz. The exposures were made in a square pattern approximately 20 mm by 20 mm. Six individual exposures were made at near constant laser power but at various scan speeds. The parallel scan lines making up each exposure were drawn approximately 50 μm apart. Based upon knowledge of the diameter of the focused beam at the liquid surface, the scan speed, the laser power, and the scan spacing, the summation of exposure mJ/cm² was calculated. Each square was allowed to float on the surface of the petri-dish for approximately 15 minutes. Then the squares were blotted and a thickness measurement was taken using Mitutoyo NTO25-8° C. spring loaded Absolute Digimatic calipers. When the natural log of the exposures is plotted against the measured thickness a least squares fit line can be drawn. The Dₚ (μm) is the slope of the least squares fit line. The E_{c} (mJ/cm²) is the X-axis crossing point (Y=0) of the line. And the E10 is the energy necessary to produce a layer that was approximately 10 mils (254 μm) thick. In general, the lower the E10 number, the faster the photo speed of the composition.

(c) Glass Transition Temperature (Tg)

A UV and thermally postcured specimen was prepared in the same manner as described above for the preparation of a tensile bar. Part of the specimen was placed in a TA Instruments TMA 2940 at room temperature. The specimen was then heated with a ramp of 3° C./min from room temperature or below up to 250° C. under a nitrogen purge of 60 mL/min. A graph of dimension change over temperature was generated and analyzed by using TA Instrument Universal Analysis V2.6D software, which calculated the glass transition temperature from a sudden change in the slope of the thermal expansion curve.

(d) UL94

UL94 specimens for 20 mm Vertical Burning Test were prepared in the same manner as described above for the preparation of a UV-postcured tensile bar. The specimens were typically 125 mm in length and 13 mm in width, and 3.2 mm, 1.6 mm, or 0.8 mm in thickness. The vertical burning test to classify materials as V-0, V-1 or V-2 was run at least one day after preparation of the bar specimen and in accordance with UL94 which is hereby incorporated in its entirety by reference, except that no provision was made for controlling the room temperature and humidity and the bars were not equilibrated for 2 days.

Thickness of the test specimens is also important for the interpretation of the test results. It is more difficult to pass the UL94 vertical burning test for a thinner specimen than for a thicker one. Nevertheless, no attempt was made to prepare and test specimens from the compositions disclosed in the present invention with a thickness of greater than 3.2 mm, even though some compositions might have been rated as UL94 V0 at a thickness of greater than 3.2 mm. Likewise, no attempt was made to prepare and test specimens from the compositions disclosed in the present invention with a thickness of less than 0.8 mm, even though some compositions might have been rated as UL94 V0 at a thickness of smaller than 0.8 mm.

Having described specific embodiments of the present invention, it will be understood that many modifications thereof will readily be apparent to those skilled in the art, and it is intended therefore that this invention be limited only by the spirit and scope of the following claims.

TABLE 1
Glossary

| Commercial Name (Supplier) | Description |
|---|---|
| EPON 825 (Resolution Performance | bisphenol A diglycidyl ether (aromatic epoxy) |
| Products) | |
| EPICLON N-740 (Dainippon Ink & | phenol epoxy novolac (aromatic epoxy) |
| Chemical) | |
| UVACURE 1500 (UCB Radcure) | 3,4-epoxy cyclohexyl methyl-3,4-epoxy cyclohexyl |
| | carboxylate (aliphatic epoxy) |
| Cyracure UVR-6105 (Dow Chemical) | 3,4-epoxy cyclohexyl methyl-3,4-epoxy cyclohexyl |
| | carboxylate (aliphatic epoxy) |
| UVR 6000 (Dow Chemical) | 3-ethyl-3-hydroxymethyl-oxetane (oxetane) |
| Oxetane-221 (Toagosei) | bis[1-ethyl(3-oxetanyl)]methyl ether |
| Epon-1163 (Resolution Performance | brominated bisphenol A diglycidyl ether |
| Products) | |
| DER 542 (Dow Chemical) | brominated bisphenol A diglycidyl ether |
| DER 560 (Dow Chemical) | brominated bisphenol A diglycidyl ether |
| Heloxy 107 (Resolution Performance | cyclohexanedimethanol diglycidyl ether |
| Products) | |
| Neopentyl glycol diglycidyl ether, | 2,2-bis(bromomethyl)-1,3-propanediol polymer with |
| brominated (Aldrich) | (chloromethyl)oxirane |
| Nanopox XP 22/0516 (Hanse Chemie) | 40% silica nanoparticles in bisphenol A diglycidyl |
| | ether |
| Sunsphere NP-100 (Asahi Glass) | amorphous silica |
| SR-399 (Sartomer) | monohydroxy dipentaerythritol pentaacrylate |
| SR-238 (Sartomer) | 1,6-hexanediol diacrylate |
| 2,2′,6,6′-Tetrabromobisphenol A ethoxylate | tetrabromobisphenol A bis(2-hydroxyethyl)ether |
| (1 EO/phenol) diacrylate (Aldrich) | bisacrylate |
| SR-340 (Sartomer) | 2-phenoxyethyl methacrylate |
| CD-540 (Sartomer) | ethoxylated (4) bisphenol A dimethacrylate |
| CN-1963 (Sartomer) | urethane methacrylate |
| CN151 (Sartomer) | epoxy methacrylate |
| SR480 (Sartomer) | ethoxylated (10) bisphenol A dimethacrylate |
| Saret ® SR 634 (Sartomer) | modified metallic dimethacrylate |
| APE1540 (Nyacol) | mixture of antimony oxides |
| ATH SpaceRite ® S-3 (Alcoa Inc) | aluminum trihydrate |
| ATH SpaceRite ® S-23 (Alcoa Inc) | aluminum trihydrate |
| FireBrake ® ZB-XF (US Borax Inc) | zinc borate |
| 4,4′-Isopropylidenebis[2-(2,6- | tetrabromobisphenol A bis(2-hydroxyethyl oxide) |
| dibromophenoxy)ethanol] (Aldrich) | |
| PHT4 Diol (Great Lakes Polymer Additives) | 2-(2-hydroxyethoxy)ethyl 2-hydroxypropyl 3,4,5,6- |
| | tetrabromophthalate |
| BA-59P (Great Lakes Polymer Additives) | tetrabromobisphenol A |
| BE-51 (Great Lakes Polymer Additives) | tetrabromobisphenol A diallyl ether |
| DE-60FS (Great Lakes Polymer Additives) | pentabromodiphenyl oxide blend |
| FM BZ-54 (Great Lakes Polymer Additives) | tetrabromophthalic anhydride derivative |
| FR-372 (Ameribrom Inc. USA) | tris(tribromoneopentyl) phosphate |
| Reofos BAPP (Great Lakes Polymer | phosphoric trichloride reaction product with |
| Additives); ADK stab FP-700 | bisphenol A and phenol |
| Fyrolflex BDP (Akzo Nobel Functional | bisphenol A bis(diphenyl phosphate) |
| Chemicals) | |
| Ncendx P-30 (Albemarle Corp) | phosphoric trichloride reaction products with |
| | bisphenol A and phenol |
| CR-741 (Ameribrom Inc. USA) | Bisphenol-A tetraphenyl diphosphate |
| Erisys GE-29 (CVC Speciality Chemicals, | Dibromoneopentyl glycol-epichlorohydrin |
| INC) | copolymer |
| Fyrolflex RDP (Akzo Nobel) | Resorcinol bis(diphenyl phosphate) |
| Phosflex TPP (Akzo Nobel) | triphenyl phosphate |
| IRGACURE 184 (Ciba Geigy) | 1-hydroxycyclohexyl phenyl ketone |
| Irgacure 651 | 2,2-dimethoxy-1,2-diphenyl-ethanone |
| CPI-6976 (Aceto) | mixture of triarysulfonium hexafluoroantimonate |
| | salts |
| Chivacure-1176 (Chitec) | mixture of triarysulfonium hexafluoroantimonate |
| | salts |
| SILWET L-7600 (OSI Specialities) | Surfactant |
| BYK-A-501 (BYK-Chemie) | Defoamer |
| PVP (Aldrich) | stabilizer (polyvinylpyrolidone, Mw ca. 10,000) |

TABLE 2
Comparative Examples C1-C6

| | C1 | C2 | C3 | C4 | C5 | C6 |
|---|---|---|---|---|---|---|
| Ingredient | | | | | | |
| CPI6976 | 3.600 | 3.060 | 1.838 | 1.706 | 3.672 | 2.000 |
| Iragcure 184 | 2.800 | 2.380 | 0.490 | 0.455 | 2.766 | 0.750 |
| PVP | 0.005 | 0.004 | | | | 0.003 |
| Sliwet L-7600 | 0.200 | 0.170 | 0.199 | 0.120 | 0.191 | 0.100 |
| BYK A501 | 0.020 | 0.017 | 0.020 | 0.005 | 0.019 | 0.010 |
| SR399 | 11.000 | 9.350 | 2.489 | 2.300 | 2.861 | 5.500 |
| SR238 | | | 2.987 | 2.000 | 2.861 | |
| UVR6000 | 15.500 | 13.175 | 7.467 | 6.000 | 9.537 | 10.000 |
| UVC1500 | | | 7.965 | 7.000 | | 6.250 |
| Epon825 | 23.875 | 20.294 | 4.978 | 5.000 | | 25.388 |
| Epiclon N-740 | 13.000 | 11.050 | | | | |
| Epon 1163 | | | 9.956 | 9.614 | | |
| DER 560 | 30.000 | 25.500 | | | | |
| Nanopox XP 22/0516 | | | 2.987 | 5.000 | 59.609 | |
| Sunsphere NP-100 | | | 57.528 | 57.500 | | |
| ATH SpaceRite ® S-3 | | | | | | 50.000 |
| BA-59P | | | 0.199 | 0.300 | | |
| DE-60FS | | | 0.896 | | | |
| Firemaster BZ-54 | | 15.000 | | 3.000 | | |
| CR-741 | | | | | 14.306 | |
| Phosflex TPP | | | | | 4.177 | |
| Br % (in organic matrix) | 15.0 | 20.9 | 13.5 | 16.3 | | |
| P % (in organic matrix) | | | | | 2.2 | |
| Silica % | | | 58.7 | 59.5 | 23.8 | |
| ATH % | | | | | | 50.0 |
| Br % (in composition) | 15.00 | 20.85 | 5.56 | 6.60 | | |
| P % (in composition) | | | | | 1.66 | |
| Test Results | | | | | | |
| UL94 V-0 | Fail | Fail | Fail | Fail | Fail | Fail |
| E_{c} (mJ/cm²) | 12.0 | 6.7 | 12.7 | 7.1 | 15.0 | 4.0 |
| Dₚ (μm) | 141 | 129 | 153 | 130 | 128 | 143 |
| E₁₀ (mJ/cm²) | 72.1 | 48.1 | 66.9 | 50.0 | 108.2 | 23.4 |
| UV postcured | | | | | | |
| Young's modulus [MPa] | 3628 | 2421 | 11366 | 9283 | 2841 | 7552 |
| Tensile strength [MPa] | 41 | 43 | 40 | 28 | 39 | 24 |
| Elongation at break [%] | 1.3 | 4.2 | 0.5 | 0.4 | 7.1 | 0.4 |
| ZUV and thermal postcured | | | | | | |
| Young's modulus [MPa] | 3297 | 3379 | 10772 | 10345 | | 6931 |
| Tensile strength [MPa] | 73 | 29 | 76 | 69 | | 37 |
| Elongation at break [%] | 3.2 | 1.0 | 1.1 | 0.9 | | 0.6 |

TABLE 3
Comparative Examples C7-C14

| | C7 | C8 | C9 | C10 | C11 | C12 | C13 | C14 |
|---|---|---|---|---|---|---|---|---|
| Ingredient | | | | | | | | |
| CPI-6976 or Chivacure-1176 | 1.500 | 4.238 | 3.997 | 4.000 | 4.046 | 4.327 | 4.010 | 3.297 |
| Irgacure 184 | 0.400 | 1.815 | 1.673 | 1.500 | 1.789 | 1.461 | 1.391 | 1.236 |
| Silwet L-7600 | 0.200 | 0.145 | 0.186 | 0.200 | 0.155 | 0.156 | 0.188 | 0.165 |
| BYK A501 | 0.020 | 0.015 | 0.019 | 0.020 | 0.016 | 0.016 | 0.019 | 0.016 |
| SR399 | 1.000 | 4.173 | 5.577 | 6.000 | 5.865 | 5.651 | 5.435 | 2.473 |
| SR238 | 3.000 | | 4.648 | 5.000 | 5.724 | 4.629 | 4.337 | 4.122 |
| UVR6000 | 5.000 | 17.487 | | 16.000 | | 15.246 | 14.333 | 9.892 |
| UVC1500 | 7.000 | | | | | | | |
| UVR-6105 | | | 25.097 | | | | | |
| Epon825 | 3.800 | 33.874 | 15.504 | 35.280 | 28.907 | 32.384 | 21.569 | 20.608 |
| Epon 1163 | 8.500 | | 11.154 | 22.000 | 15.549 | 21.113 | 19.912 | |
| DER 542 | | 14.518 | | | | | | |
| Nanopox XP 22/0516 | 2.500 | | | | | | 18.803 | |
| Sunsphere NP-100 | 57.800 | | | | | | | |
| ATH SpaceRite ® S-23 | | | | | | | | 45.001 |
| Ethoxylated TBBA Diol | | | 11.154 | | 15.545 | | | |
| BA-59P | 0.200 | | | | | | | |
| Heloxy 107 | | | 7.048 | | | | | |
| Fyrolflex BDP | | | 8.366 | | | | | |
| Ncendx P-30 | | 15.025 | | | | | | 6.595 |
| CR-741 | 9.080 | | | | | | | |
| Ethoxylated TBBA diacrylate | | 8.711 | | | | | | |
| Fyrolflex RDP | | | 5.577 | 10.000 | 5.028 | 15.018 | 10.003 | |
| Phosflex TPP | | | | | | | | 6.595 |
| Oxetane-221 | | | | | 17.375 | | | |
| Br % (in organic matrix) | 10.6 | 11.0 | 11.2 | 11.0 | 15.6 | 10.6 | 10.8 | |
| P % (in organic matrix) | 1.9 | 1.3 | 1.3 | 1.1 | 0.6 | 1.7 | 1.2 | 2.2 |
| Silica % | 58.8 | | | | | | 7.5 | |
| ATH % | | | | | | | | 45.0 |
| Br % (in composition) | 4.4 | 11.0 | 11.2 | 11.0 | 15.6 | 10.6 | 10.0 | |
| P % (in composition) | 0.8 | 1.3 | 1.3 | 1.1 | 0.6 | 1.7 | 1.1 | 1.2 |
| Test Results | | | | | | | | |
| UL94 V-0 | Fail | Fail | Fail | Fail | Fail | Fail | Fail | Fail |
| E_{c} (mJ/cm²) | 12.2 | 7.3 | 11.8 | 10.8 | 11.3 | 11.1 | 10.0 | 8.6 |
| Dₚ (μm) | 125 | 128 | 133 | 133 | 140 | 130 | 113 | 142 |
| E₁₀ (mJ/cm²) | 92.2 | 53.3 | 79.1 | 73.1 | 69.1 | 78.4 | 95.2 | 51.0 |
| UV postcured | | | | | | | | |
| Young's modulus [MPa] | 7697 | 3207 | 2952 | | 2903 | 2421 | 3552 | 1966 |
| Tensile strength [MPa] | 32 | 61 | 45 | | 42 | 53 | 69 | 17 |
| Elongation at break [%] | 0.8 | 3.4 | 2.0 | | 1.7 | 5.2 | 2.5 | 4.2 |
| UV and thermal postcured | | | | | | | | |
| Young's modulus [MPa] | 9490 | 3517 | 3400 | 3076 | 3345 | 2724 | 3172 | |
| Tensile strength [MPa] | 44 | 74 | 74 | 80 | 58 | 70 | 72 | |
| Elongation at break [%] | 0.8 | 3.9 | 2.7 | 5.1 | 2.5 | 5.0 | 4.0 | |
| T_{g} [° C.] | | 55 | 54 | 92 | 90 | 51 | 39 | |

TABLE 4
Examples 1-5

| | EX 1 | EX 2 | EX 3 | EX 4 | EX 5 |
|---|---|---|---|---|---|
| Ingredient | | | | | |
| CPI6976 | 3.025 | 2.641 | 3.504 | 3.500 | 3.601 |
| Irgacure 184 | 1.492 | 1.303 | 1.234 | 1.250 | 2.300 |
| PVP | 0.003 | 0.002 | | | |
| Silwet L-7600 | 0.107 | 0.093 | 0.162 | 0.100 | 0.074 |
| BYK A501 | 0.011 | 0.009 | 0.016 | 0.010 | 0.007 |
| SR399 | 5.862 | 5.119 | 8.779 | 6.000 | 4.458 |
| UVR6000 | 8.260 | 7.213 | 6.837 | | 9.881 |
| UVC1500 | | 12.671 | 11.860 | 15.000 | 11.146 |
| Epon825 | 12.723 | 11.110 | 14.243 | 9.000 | 6.688 |
| Epiclon N-740 | 6.927 | 6.050 | 5.697 | | |
| Epon 1163 | | | 13.009 | 12.000 | 8.917 |
| DER 560 | 15.987 | 13.961 | | | |
| ATH SpaceRite ® S-3 | | | | 5.000 | 3.715 |
| ATH SpaceRite ® S-23 | 36.201 | 31.614 | 29.911 | 36.140 | 26.855 |
| BA-59P | | | 4.748 | 3.000 | 2.229 |
| Firemaster BZ-54 | 9.404 | 8.212 | | 9.000 | 6.688 |
| Fyrolflex BDP | | | | | 13.439 |
| Br % (in organic matrix) | 20.5 | 16.7 | 13.3 | 21.5 | 13.5 |
| P % (in organic matrix) | | | | | 1.7 |
| ATH % | 36.2 | 31.6 | 29.9 | 41.1 | 30.6 |
| Br % (in composition) | 13.1 | 11.4 | 9.3 | 12.6 | 9.4 |
| P % (in composition) | | | | | 1.2 |
| Test Results | | | | | |
| Thickness rated UL94 V0 (mm) | 1.6 | 1.6 | 1.6 | 1.6 | 1.6 |
| E_{c} (mJ/cm²) | 13.2 | 13.5 | 13.4 | 12.6 | 10.5 |
| Dₚ (μm) | 133 | 160 | 142 | 138 | 140 |
| E₁₀ (mJ/cm²) | 89.1 | 66.3 | 80.2 | 79.4 | 64.2 |
| UV postcured | | | | | |
| Young's modulus [MPa] | | 3931 | 5166 | 4986 | 1310 |
| Tensile strength [MPa] | | 30 | 18 | 19 | 16 |
| Elongation at break [%] | | 1.3 | 0.4 | 0.5 | 6.4 |
| UV and thermal postcured | | | | | |
| Young's modulus [MPa] | | | 5745 | | |
| Tensile strength [MPa] | | | 40 | | |
| Elongation at break [%] | | | 0.8 | | |

TABLE 5
Examples 6-13

| | EX 6 | EX 7 | EX 8 | EX 9 | EX 10 | EX 11 | EX 12 | EX 13 |
|---|---|---|---|---|---|---|---|---|
| Ingredient | | | | | | | | |
| CPI6976 | 3.602 | 3.600 | 4.200 | 3.520 | 3.099 | 3.705 | 3.600 | 3.300 |
| Irgacure 184 | 2.800 | 2.800 | 1.572 | 2.452 | 2.159 | 1.705 | 2.500 | 2.300 |
| PVP | | 0.004 | | | | | | |
| Silwet L-7600 | 0.099 | 0.143 | 0.126 | 0.119 | 0.104 | 0.200 | 0.200 | 0.200 |
| BYK A501 | 0.010 | 0.014 | 0.013 | 0.012 | 0.010 | 0.020 | 0.020 | 0.020 |
| SR399 | 9.118 | 7.870 | 5.988 | 6.472 | 5.697 | 4.671 | 4.000 | 6.000 |
| SR238 | | | 5.979 | 3.559 | 3.133 | 3.959 | | 6.000 |
| UVR6000 | 10.855 | 10.732 | | 8.898 | 7.833 | 13.100 | 15.000 | |
| UVC1500 | 9.375 | | | | | | | |
| UVR-6105 | | | | | 11.966 | | | |
| Epon825 | 9.868 | 9.427 | 29.990 | 21.948 | 19.322 | | 32.680 | 37.180 |
| Epiclon N-740 | 6.908 | 6.439 | | 5.564 | 4.898 | | | |
| Epon 1163 | 24.670 | 16.098 | | | | 38.378 | | 20.000 |
| DER 542 | | 16.098 | 13.543 | | | | 20.000 | |
| Ethoxylated TBBA Diol | | | 9.434 | | | | | 20.000 |
| DE-60FS | | 7.109 | | 14.237 | 12.533 | | | |
| FM BZ-54 | | | | 18.982 | 16.711 | | | |
| Fyrolflex BDP | | 19.664 | | | | | | |
| Ncendx P-30 | | | | | | | 10.000 | |
| CR-741 | 19.736 | | | | | | | |
| Ethoxylated TBBA diacrylate | | | | | | | 12.000 | |
| Fyrolflex RDP | | | | 14.237 | 12.533 | | | 5.000 |
| Phosflex TPP | | | 3.145 | | | | | |
| ADK Stab FP-700 | | | | | | 5.038 | | |
| FR-372 | 2.960 | | | | | | | |
| Brominated neopentyl | | | 26.010 | | | | | |
| glycol diglycidyl ether | | | | | | | | |
| Erisys GE-29 | | | | | | 29.224 | | |
| Br % (in organic matrix) | 14.4 | 19.8 | 19.5 | 17.7 | 15.5 | 28.1 | 15.2 | 20.1 |
| P % (in organic matrix) | 1.8 | 1.7 | 0.3 | 1.6 | 1.4 | 0.4 | 0.9 | 0.6 |
| Test Results | | | | | | | | |
| Thickness rated UL94 V0 (mm) | 3.2 | 3.2 | 3.2 | 1.6 | 1.6 | 0.8 | 3.2 | 0.8 |
| E_{c} (mJ/cm²) | 10.2 | 16.8 | 12.2 | 11.6 | 12.7 | 14.3 | 7.3 | 13.1 |
| Dₚ (μm) | 146 | 145 | 121 | 116 | 145 | 140 | 128 | 130 |
| E₁₀ (mJ/cm²) | 57.8 | 96.3 | 98.5 | 102.8 | 73.7 | 88 | 53.3 | 92.3 |
| UV postcured | | | | | | | | |
| Young's modulus [MPa] | 1448 | 1448 | 2007 | 103 | 338 | 3300 | 2834 | 3124 |
| Tensile strength [MPa] | 17 | 22 | 36 | 7 | 11 | 60 | 54 | 9 |
| Elongation at break [%] | 1.7 | 6.3 | 4.9 | 16.8 | 16.6 | 6.4 | 2.4 | 0.3 |
| UV and thermal postcured | | | | | | | | |
| Young's modulus [MPa] | | 2690 | 3488 | | | 3220 | 3352 | 3910 |
| Tensile Strength [MPa] | | 56 | 76 | | | 62 | 83 | 33 |
| Elongation at break [%] | | 4.5 | 5.3 | | | 6.7 | 4.6 | 0.9 |
| T_{g} [° C.] | | | 38 | | | | 92 | 83 |

TABLE 6
Examples 14-21

| | EX 14 | EX 15 | EX 16 | EX 17 | EX 18 | EX 19 | EX 20 | EX 21 |
|---|---|---|---|---|---|---|---|---|
| Ingredient | | | | | | | | |
| CPI6976 | 1.548 | 3.948 | 3.500 | 2.974 | 3.009 | 3.600 | 4.000 | 3.600 |
| Irgacure 184 | 0.413 | 1.481 | 2.280 | 1.937 | 2.000 | 2.500 | 1.500 | 2.500 |
| Silwet L-7600 | 0.109 | 0.197 | 0.200 | 0.170 | 0.151 | 0.200 | 0.200 | 0.200 |
| BYK A501 | 0.005 | 0.020 | 0.020 | 0.017 | 0.015 | 0.020 | 0.020 | 0.020 |
| SR399 | 2.087 | 7.896 | 3.000 | 2.549 | 3.437 | 4.000 | 3.000 | 4.000 |
| SR238 | 1.815 | | 4.000 | 3.399 | 3.324 | 4.000 | 5.000 | 4.000 |
| UVR6000 | 5.444 | 10.857 | 12.000 | 10.196 | 9.530 | 14.000 | | 14.000 |
| UVC1500 | 6.352 | | | | | | | |
| UVR-6105 | | | | 15.031 | 14.167 | | 9.000 | |
| Epon825 | 4.537 | 8.883 | | | 5.451 | 6.680 | | |
| Epiclon N-740 | | | | | 1.382 | | | |
| Epon 1163 | 8.724 | 20.510 | 15.000 | 12.745 | 9.150 | 15.000 | | 15.000 |
| DER 542 | | | 15.000 | 12.745 | 9.150 | 20.000 | 10.000 | 20.000 |
| Nanopox XP 22/0516 | 4.537 | 24.676 | 25.000 | 21.242 | 15.250 | 25.000 | 25.000 | 25.000 |
| Sunsphere NP-100 | 52.174 | | | | | | | |
| PHT4 Diol | | | | | | | 24.000 | |
| BA-59P | 0.272 | 0.494 | | | | | | |
| DE-60FS | | | | | 3.536 | | | |
| FM BZ-54 | 2.722 | | | | 4.714 | | | |
| Reofos BAPP | | 11.168 | 15.000 | 12.745 | 9.150 | | 18.280 | |
| Ncendx P-30 | | | | | | 5.000 | | 11.680 |
| CR-741 | 7.216 | | | | | | | |
| Fyrolflex RDP | | | | | 3.536 | | | |
| Phosflex TPP | | 9.870 | 5.000 | 4.248 | 3.050 | | | |
| FR-372 | 2.046 | | | | | | | |
| Br % (in organic matrix) | 16.1 | 11.7 | 16.7 | 13.9 | 14.4 | 19.4 | 17.8 | 19.4 |
| P % (in organic matrix) | 1.5 | 2.1 | 2.0 | 1.7 | 1.6 | 0.5 | 1.8 | 1.1 |
| Silica % | 54.0 | 9.9 | 10.0 | 8.5 | 6.1 | 10.0 | 10.0 | 10.0 |
| Br % (in composition) | 7.4 | 10.5 | 15.0 | 12.7 | 13.5 | 17.5 | 16.0 | 17.5 |
| P % (in composition) | 0.7 | 1.9 | 1.8 | 1.5 | 1.5 | 0.4 | 1.6 | 1.0 |
| Test Results | | | | | | | | |
| Thickness rated UL94 V0 (mm) | 0.8 | 3.2 | 3.2 | 3.2 | 3.2 | 3.2 | 1.6 | 3.2 |
| E_{c} (mJ/cm²) | 7.1 | 11.2 | 11.9 | 11.0 | 11.5 | 8.2 | 13.1 | 8.6 |
| D_{P} (μm) | 129 | 135 | 130 | 146 | 145 | 123 | 113 | 122 |
| E₁₀ (mJ/cm²) | 51.4 | 73.6 | 83.8 | 62.4 | 65.8 | 63.6 | 124.2 | 69.0 |
| UV postcured | | | | | | | | |
| Young's modulus [MPa] | 6166 | 1717 | 2241 | 1883 | 993 | 3083 | 1952 | 3262 |
| Tensile strength [MPa] | 19 | 26 | 35 | 13 | 15 | 29 | 17 | 34 |
| Elongation at break [%] | 0.5 | 14.3 | 13.6 | 1.0 | 10.7 | 1.2 | 1.3 | 1.3 |
| UV and thermal postcured | | | | | | | | |
| Young's modulus [MPa] | | 2655 | | | | 3869 | | 3903 |
| Tensile strength [MPa] | | 38 | | | | 44 | | 44 |
| Elongation at break [%] | | 3.4 | | | | 1.3 | | 1.7 |
| T_{g} [° C.] | | | | | | 87 | | 55 |

TABLE 7
Radically Polymerizable Compositions

| | C15 | C16 | C17 | C18 | Ex 22 | Ex 23 |
|---|---|---|---|---|---|---|
| Ingredient | | | | | | |
| Irgacure 651 | 3.283 | 2.371 | 1.641 | 1.892 | 1.135 | 1.079 |
| SR340 | 25.837 | 18.660 | 12.919 | 14.891 | 8.935 | 8.488 |
| CD540 | 14.675 | 10.598 | 7.337 | 8.458 | 5.075 | 4.821 |
| CN1963 | 22.751 | 16.431 | 11.376 | 13.113 | 7.868 | 7.474 |
| CN151 | 25.378 | 18.328 | 12.689 | 14.626 | 8.776 | 8.337 |
| SR480 | 8.076 | 5.833 | 4.038 | 4.655 | 2.793 | 2.653 |
| ATH SpaceRite ® S-3 | | | 25.000 | | 20.000 | 19.000 |
| ATH SpaceRite ® S-23 | | | 25.000 | | 20.000 | 19.000 |
| Firemaster BZ-54 | | 27.779 | | 22.169 | 13.301 | 12.636 |
| APE1540 | | | | 20.196 | 12.118 | 11.512 |
| Saret SR 634 | | | | | | 5.000 |
| Br % (in organic matrix) | | 15.00 | | 13.02 | 13.02 | 12.32 |
| ATH % | | | 50.00 | | 40.00 | 38.00 |
| Sb % | | | | 6.08 | 3.65 | 3.47 |
| Test Results | | | | | | |
| Thickness Rated UL94 V0 (mm) | N/A | Fail | Fail | Fail | 0.8 | 1.6 |
| E_{c} (mJ/cm²) | 4.4 | 6.0 | 2.2 | 4.0 | 3.6 | 2.4 |
| Dₚ (mils) | 146 | 158 | 148 | 76 | 97 | 85 |
| E₁₀ (mJ/cm²) | 25 | 30 | 12 | 112 | 48 | 49 |
| Young's modulus [MPa] | 2490 | 1103 | 5993 | 448 | 1290 | 1476 |
| Tensile strength [MPa] | 43 | 24 | 28 | 12 | 14 | 10 |
| Elongation at break [%] | 3.1 | 4.8 | 0.6 | 10.0 | 3.4 | 1.1 |

1. A radiation curable composition comprising radiation curable components wherein the composition comprises at least two flame retardants and wherein the flame retardants belong to different classes of compounds.

2. The composition according to claim 1, wherein the composition comprises cationically polymerizable components and radically polymerizable components.

3. The composition according to claim 1, wherein the composition comprises between 20 and 90 wt % of cationically curable components.

4. The composition according to claim 1, wherein the composition comprises at least one component selected from the group consisting of epoxy-functional components and oxetane functional components.

5. The composition according to claim 1, wherein the composition comprises between 3 and 60 wt % of one or more free radical polymerizable components,

6. The composition according to claim 1, wherein the composition comprises one or more components having at least 3 (meth)acrylate groups.

7. The composition according to claim 1, wherein the composition comprises 0.1-15 wt % of one or more free radical photoinitiators, and 0.1-15 wt % of one or more cationic photoinitiators.

8. The composition according to claim 1, wherein the flame retardants are chosen from the group consisting of brominated compounds, P-containing compounds and aluminum hydroxide.

9. The composition according to claim 8, wherein the Br-containing flame retardant is chosen from the group consisting of bromine-containing epoxy resins/oligomers/prepolymers, Br-containing acrylates/methacrylates, Br-containing polyols and polyphenols, and brominated oxetanes, or a combination of two or more of the above.

10. The composition according to claim 8, wherein the halogen-containing flame retardant forms a solution with other organic ingredients in the composition.

11. The composition according to claim 8, wherein the compositions comprises, relative to the total weight of the organic fraction of the composition, between 5 wt % and 30 wt % of [Br] from the Br-containing flame retardant, wherein [Br] is the wt % of (the element) Br in the organic fraction of the composition.

12. The composition according to claim 8, wherein the phosphorus-containing flame retardants is selected from the group consisting of aromatic phosphate esters and biphosphate esters.

13. The composition according to claim 8, wherein the P-containing flame retardant is having one or more reactive groups selected from the group consisting of hydroxyls, oxetanes, epoxies, methacrylates or acrylates.

14. The composition according to claim 1, wherein the composition comprises between 0.1 wt % and 3.5 wt % of [P] from the P-containing flame retardants, wherein [P] is the wt % of (the element) phosphorous in the organic part of the resin composition.

15. The composition according to claim 1, wherein the composition comprises at least one bromine-containing flame retardant and at least one P-containing flame retardant, whereby the amount of Br- and P-containing flame retardant is defined by the formula:
5≦[P]+0.25*[Br]≦10
wherein [P] is the wt % of (the element) phosphorous in the organic part of the resin composition, [Br] is the wt % of (the element) Br in the organic part of the resin composition, and wherein [P]>0.1 wt %.

16. The composition according to claim 15, wherein [P]>0.2 wt %.

17. The composition according to claim 1, wherein the composition comprises at least one bromine-containing flame retardant and at least one P-containing flame retardant, whereby the amount of Br- and P-containing flame retardant is defined by the formula:
5≦[P]+0.25*[Br]≦8,
wherein [P] is the wt % of (the element) phosphorous in the organic part of the resin composition, [Br] is the wt % of (the element) Br in the organic part of the resin composition, and wherein [P]>0.1 wt %.

18. The composition according to claim 17, wherein [P]>0.25 wt %.

19. The composition according to claim 1, wherein the composition comprises between 20 and 60 wt % of an inorganic flame retardant.

20. A method for making a three dimensional object, comprising the steps of
1) coating a layer of a composition onto a surface;
2) exposing said layer imagewise to actinic radiation to form an imaged cross-section;
3) coating a further layer of the composition onto said imaged cross-section;
4) exposing said further layer imagewise to actinic radiation to form an additional imaged cross-section;
5) repeating steps (3) and (4) a sufficient number of times in order to build up a three dimensional article;
6) optionally, post-curing the three-dimensional article,
wherein the composition comprises one or more flame retardants, wherein the composition can be cured to a test specimen having a size of 125 mm in length, 13 mm in width and 3.2 mm thickness and wherein the testpiece after UV-postcure passes the UL-94-V0 flammability test.

21. The method according to claim 20, wherein the test specimen has a thickness of 0.8 mm.

22. A method for making a three dimensional object, comprising the steps of
(1) coating a layer of a composition onto a surface;
(2) exposing said layer imagewise to actinic radiation to form an imaged cross-section;
(3) coating a further layer of the composition onto said imaged cross-section;
(4) exposing said further layer imagewise to actinic radiation to form an additional imaged cross-section;
(5) repeating steps (3) and (4) a sufficient number of times in order to build up a three dimensional article;
(6) optionally, post-curing the three-dimensional article, wherein the composition is defined according to anyone of claims 119 claim 1.

23. Use of a radiation curable composition comprising one or more flame retardants for making three dimensional objects, wherein a test specimen having a size of 125 mm in length, 13 mm in width and 3.2 mm thickness, which is fully cured, passes the UL-94-V0 flammability test.

24. A three dimensional article, made by rapid prototyping means, that passes the flame retardancy UL-94-V0 test.
